(19) United States
(12) Patent Application Publication
(10) Pub. No.: US 2016/0137792 A1
(43) Pub. Date: May 19, 2016

(54) FIBER-REINFORCED COMPOSITE

(71) Applicant: Borealis AG, Vienna (AT)

(72) Inventors: Markus Hemmeter, Weissenburg (DE); Markus Kralicek, Linz (AT)

(21) Appl. No.: 14/436,809

(22) PCT Filed: Oct. 18, 2013
(86) PCT No.: PCT/EP2013/071873

§ 371 Date: Apr. 17, 2015

(30) Foreign Application Priority Data
Oct. 25, 2012 (EP) 12189989.2

(51) Int. Cl. C08J 5/04

(52) U.S. Cl. CPC C08J 5/046; C08J 2323/12; C08J 2423/12

(57) ABSTRACT

The present invention relates to a fiber-reinforced composite (FR-C), an automotive article comprising the fiber-reinforced composite (FR-C) as well as the use of the fiber-reinforced composite (FR-C) for automotive articles and a process for the preparation of the fiber-reinforced composite (FR-C).

The present invention relates to a fiber-reinforced composite (FR-C), an automotive article comprising the fiber-reinforced composite (FR-C) as well as the use of the fiber-reinforced composite (FR-C) for automotive articles and a process for the preparation of the fiber-reinforced composite (FR-C).

Polypropylene is a material used in a wide variety of technical fields and reinforced polypropylenes have in particular gained relevance in fields previously exclusively relying on non-polymeric materials, in particular metals. One particular example of reinforced polypropylenes is glass fiber reinforced polypropylenes, metal reinforced polypropylenes or talc reinforced polypropylenes such as described in EP 1 357 144 B1, EP 0 206 034 A1, U.S. Pat. No. 5,382,459, WO 2008/074715 A1, WO 2012/025592 A1. Such materials enable a tailoring of the properties of the composition by selecting the type of polypropylene, the amount of fiber and sometimes by selecting the type of coupling agent used. Accordingly, nowadays fiber reinforced polypropylenes are well established materials for applications requiring high stiffness, heat deflection resistance and resistance to both impact and dynamic fracture loading (examples include automotive components with a load-bearing function in the engine compartment, support parts for polymer body panels, washing machine and dishwasher components). Desired properties include inter alia high scratch resistance, light weight (i.e. low density), high impact strength and high tensile strength and strain. Many efforts have been made to provide a good balance between these properties.

However, one specific drawback of the commercial available fiber-reinforced materials is that the weight of such materials increases through the filler incorporation resulting in a higher weight of the final application. Furthermore, the material of the fibers typically differs from the material of the matrix in which the fibers are dispersed such that a recycling of the known fiber reinforced materials is difficult.

In view of the foregoing, improving fiber-reinforced materials still remains of interest to the skilled person. It would be especially desirable to provide an alternative or improved fiber-reinforced material which is of light weight and is easy to recycle and especially maintains mechanical properties such as the tensile modulus, tensile stress and strain.

Accordingly the object of the present is to provide a fiber-reinforced composite which is of a light weight and is easy to recycle and, further provides a superior balance of mechanical properties, like high tensile modulus, tensile stress and strain.

The finding of the present invention is to provide a fiber-reinforced material of one class of material, i.e. a fiber-reinforced material of polyolefins only.

The foregoing and other objectives are solved in particular by the subject-matter as defined herein in the present invention.

According to a first aspect of the present invention, a fiber-reinforced composite (FR-C) is provided, comprising
a) a matrix (M) comprising a polypropylene (PP), and
b) olefin homopolymer fibers (F-OH) and/or olefin copolymer fibers (F-OC) dispersed in said matrix.

The inventors surprisingly found out that the foregoing fiber-reinforced composite (FR-C) according to the present invention results in a material of light weight at final application, which is easy to recycle, while maintaining the mechanical properties, like tensile modulus, tensile stress and strain. A further advantage of the present invention is that a fiber-reinforced material can be provided with low thermal residues.

When in the following reference is made to preferred embodiments or technical details of the inventive fiber-reinforced composite, it is to be understood that these preferred embodiments or technical details also refer to the inventive automotive article and use as well as the process for the preparation of the fiber-reinforced composite as defined herein and vice versa (as far as applicable). If, for example, it is set out that the matrix of the fiber-reinforced composite comprises a propylene homopolymer (H-PP1) and/or a propylene copolymer (C-PP1) also the matrix of the inventive automotive article as well as the inventive use and the process for the preparation of the fiber-reinforced composite comprises a propylene homopolymer (H-PP1) and/or a propylene copolymer (C-PP1).

Where an indefinite or definite article is used when referring to a singular noun, e.g. “a”, “an” or “the”, this includes a plural of that noun unless something else is specifically stated.

According to another aspect of the present invention, an automotive article comprising the fiber-reinforced composite (FR-C) is provided. It is preferred that the automotive article is an exterior or interior automotive article. According to a still further aspect of the present invention, the use of the fiber-reinforced composite (FR-C) for automotive articles is provided. According to another aspect of the present invention, a process for the preparation of the fiber-reinforced composite (FR-C) is provided, the process comprising the steps of
a) providing the matrix (M) consisting of a polypropylene (PP),
b) providing the olefin homopolymer fibers (F-OH) and/or olefin copolymer fibers (F-OC),
c) impregnating the olefin homopolymer fibers (F-OH) and/or olefin copolymer fibers (F-OC) of step b) with the matrix (M) of step a) such as to obtain said fiber-reinforced composite (FR-C).

The term “impregnating” as used in the instant invention is in particular understood as the olefin homopolymer fibers (F-OH) and/or olefin copolymer fibers (F-OC) are back-moulded, over moulded, back-injected or batch compression moulded with the matrix (M).

It is preferred that impregnating step c) is carried out such that the matrix (M) of step a) is molten and/or the olefin homopolymer fibers (F-OH) and/or olefin copolymer fibers (F-OC) of step b) are substantially in solid form.

Advantageous embodiments of the present invention are defined in the corresponding sub-claims.

According to one embodiment of the present invention, the fiber-reinforced composite (FR-C) comprises
a) 50 to 99.9 wt.-% of the matrix (M), wherein said matrix (M) comprises a polypropylene (PP), and
b) 0.1 to 50 wt.-% of olefin homopolymer fibers (F-OH) and/or olefin copolymer fibers (F-OC), based on the total weight of the fiber-reinforced composite (FR-C).

wherein preferably the melting temperature of the matrix (M) is not more than 30° C. above the melting temperature of the olefin homopolymer fibers (F-OH) and/or olefin copolymer fibers (F-OC).

According to another embodiment of the present invention, the matrix (M) comprises a propylene homopolymer (H-PP1) and/or a propylene copolymer (C-PP1), preferably the matrix (M) comprises a propylene copolymer (C-PP1).

According to yet another embodiment of the present invention, the matrix (M) comprises a propylene homopolymer (H-PP1) and/or a propylene copolymer (C-PP1) having a melt flow rate MFR₂ (230° C.) measured according to ISO 1133 of from 1 to 500 g/10 min, preferably the matrix (M) comprises a propylene copolymer (C-PP1) having a melt flow rate MFR₂ (230° C.) measured according to ISO 1133 of from 1 to 500 g/10 min.

According to one embodiment of the present invention, the matrix (M) comprises a heterophasic propylene copolymer (HECO) comprising a polypropylene matrix (M-HECO), preferably the polypropylene matrix (M-HECO) is a propylene homopolymer (H-PP2), and dispersed therein an elastomeric propylene copolymer (E) comprising units derived from propylene and ethylene and/or C₄ to C₈ α-olefin. It is preferred that the heterophasic propylene copolymer (HECO) has a) a xylene cold soluble content (XCS) measured according ISO 6427 (23° C.) of not more than 35 wt.-%, and/or b) a melt flow rate MFR₂ (230° C.) measured according to ISO 1133 of from 4 to 40 g/10 min, and/or c) a total ethylene and/or C₄ to C₈ α-olefin content of 5 to 25 wt.-%, based on the total weight of the heterophasic propylene copolymer (HECO).

According to another embodiment of the present invention, the olefin homopolymer fibers (F-OH) and/or olefin copolymer fibers (F-OC) are olefin homopolymer fibers (F-OH), preferably propylene homopolymer fibers (F-PH).

According to yet another embodiment of the present invention, the olefin homopolymer fibers (F-OH) and/or olefin copolymer fibers (F-OC) are in the form of fiber bundles, preferably in the form of continuous fiber bundles.

According to one embodiment of the present invention, the melting temperature of the matrix (M) shall be not much more than the melting temperature of the olefin homopolymer fibers (F-OH) and/or olefin copolymer fibers (F-OC). Accordingly in a preferred embodiment the melting temperature of the matrix (M) and/or of the polypropylene (PP) is not more than 30° C., preferably not more than 25° C., more preferably not more than 20° C., still more preferably not more than 15° C., yet more preferably not more than 10° C., above the melting temperature of the olefin homopolymer fibers (F-OH) and/or olefin copolymer fibers (F-OC).

In the following, the inventive fiber-reinforced composite (FR-C) and its individual components are described in more detail:

Especially good results are achievable in case the fiber-reinforced composite (FR-C) comprises olefin homopolymer fibers (F-OH) and/or olefin copolymer fibers (F-OC) dispersed in a polypropylene matrix. In particular, it has been discovered that the dispersion of olefin homopolymer fibers (F-OH) and/or olefin copolymer fibers (F-OC) in a polypropylene matrix results in a material of light weight at final application, which is easy to recycle, while the mechanical properties, like high tensile modulus, tensile stress and strain are maintained.

A specific finding of the present invention is that the olefin homopolymer fibers (F-OH) and/or olefin copolymer fibers (F-OC) should be at least partially covered with the matrix (M) comprising a polypropylene (PP). In one embodiment of the present invention, the olefin homopolymer fibers (F-OH) and/or olefin copolymer fibers (F-OC) are completely covered with the matrix (M). That is to say, the olefin homopolymer fibers (F-OH) and/or olefin copolymer fibers (F-OC) are embedded in the matrix (M) of the fiber-reinforced composite (FR-C) and are thus completely surrounded by the matrix (M).

The term “composite” in the meaning of the present invention relates to a material comprising at least two components, e.g. a fiber-reinforcement and matrix, differing in composition and/or form which do not dissolve or merge completely into one another but act in concert. In other words, the single components of the composite retain their identities and form different phases within the fiber-reinforced composite.

Accordingly, one specific requirement of the present invention is that the matrix (M) has melting temperature which is in the range of the melting temperature of the olefin homopolymer fibers (F-OH) and/or olefin copolymer fibers (F-OC). Due to the similar melting temperatures of the matrix (M) on the one hand and of the olefin homopolymer fibers (F-OH) and/or olefin copolymer fibers (F-OC) on the other hand, it is avoided that the olefin homopolymer fibers (F-OH) and/or olefin copolymer fibers (F-OC) melt during the preparation of the fiber-reinforced composite (FR-C) when coming in contact with the molten matrix (M). Accordingly by selecting components having similar melting temperatures it can be avoided that the olefin homopolymer fibers (F-OH) and/or olefin copolymer fibers (F-OC) dissolve in the molten matrix (M) and form one continues phase. In other words by the specific selection of components with similar melting temperatures a fiber-reinforced composite (FR-C) is achieved, in which the fibers remain in contact and are embedded in the re-hardened matrix (M).

Thus it is preferred that the melting temperature of the matrix (M) and/or of the polypropylene (PP) is +/−30° C., more preferably +/−25° C., still more preferably +/−20° C., yet more preferably +/−15° C., still yet more preferably +/−10° C., like +/−5° C., of the melting temperature of the olefin homopolymer fibers (F-OH) and/or olefin copolymer fibers (F-OC).

As mentioned above the fiber-reinforced composite (FR-C) of the instant invention is featured by good mechanical properties. Accordingly, it is preferred that the fiber-reinforced composite (FR-C) has tensile modulus of at least 1,600 MPa, more preferably of at least 1,700 MPa, yet more preferably in the range of 1,600 to 3,500 MPa, still more preferably in the range of 1,700 to 3,200 MPa. For example, the fiber-reinforced composite (FR-C) has tensile modulus in the range of 1,600 to 3,000 MPa or in the range of 1,700 to 2,500 MPa. These values are in particular applicable in case the fiber-reinforced composite (FR-C) comprises propylene homopolymer fibers (F-PH).

It is appreciated that the fiber-reinforced composite (FR-C) has tensile modulus of at least 250 MPa above the tensile modulus of the corresponding matrix (M) and/or of the corresponding polypropylene (PP) used for preparing the fiber-reinforced composite (FR-C). For example, the fiber-reinforced composite (FR-C) has tensile modulus of at least 350 MPa above the tensile modulus of the corresponding matrix (M) used for preparing the fiber-reinforced composite (FR-C). In one embodiment of the present invention, the fiber-reinforced composite (FR-C) has tensile modulus of at least 250 MPa above the tensile modulus of the corresponding matrix (M) used for preparing the fiber-reinforced composite (FR-C), preferably of at least 350 MPa, more preferably of at least 500 MPa and most preferably of at least 600 MPa.

Furthermore, also the tensile stress at yield should be rather high. Accordingly, it is appreciated that the fiber-reinforced composite (FR-C) has a tensile stress at yield of at least 35 MPa, more preferably of at least 40 MPa, yet more preferably in the range of 35 to 100 MPa, still more preferably in the range of 40 to 90 MPa. For example, the fiber-reinforced composite (FR-C) has tensile stress at yield in the range of 40 to 85 MPa or in the range of 45 to 80 MPa. These values are in particular applicable in case the fiber-reinforced composite (FR-C) comprises propylene homopolymer fibers (F-PH).

Accordingly, the fiber-reinforced composite (FR-C) has tensile stress at yield of at least 10 MPa above the tensile stress at yield of the corresponding matrix (M) and/or of the corresponding polypropylene (PP) used for preparing the fiber-reinforced composite (FR-C).

For example, the fiber-reinforced composite (FR-C) has tensile stress at yield of at least 15 MPa above the tensile stress at yield of the corresponding matrix (M) used for preparing the fiber-reinforced composite (FR-C). In one embodiment of the present invention, the fiber-reinforced composite (FR-C) has tensile stress at yield of at least 20 MPa above the tensile modulus of the corresponding matrix (M) used for preparing the fiber-reinforced composite (FR-C), preferably of at least 25 MPa, more preferably of at least 30 MPa and most preferably of at least 40 MPa.

It is appreciated that also the tensile strain at yield should be rather high. Accordingly, it is appreciated that the fiber-reinforced composite (FR-C) has a tensile strain at yield of at least 5%, more preferably of at least 6%, yet more preferably in the range of 5 to 20%, still more preferably in the range of 6 to 15%. For example, the fiber-reinforced composite (FR-C) has tensile strain at yield in the range of 7 to 14% or in the range of 8 to 13%. These values are in particular applicable in case the fiber-reinforced composite (FR-C) comprises propylene homopolymer fibers (F-PH).

Accordingly, the fiber-reinforced composite (FR-C) has tensile strain at yield of at least 4% above the tensile strain at yield of the corresponding matrix (M) and/or of the corresponding polypropylene (PP) used for preparing the fiber-reinforced composite (FR-C). For example, the fiber-reinforced composite (FR-C) has tensile stress at yield of at least 4.5% above the tensile strain at yield of the corresponding matrix (M) used for preparing the fiber-reinforced composite (FR-C). In one embodiment of the present invention, the fiber-reinforced composite (FR-C) has tensile strain at yield of at least 5% above the tensile strain at yield of the corresponding matrix (M) used for preparing the fiber-reinforced composite (FR-C), preferably of at least 5.5%, more preferably of at least 6% and most preferably of at least 6.5%.

In one embodiment of the present invention, the fiber-reinforced composite (FR-C) should comprise the olefin homopolymer fibers (F-OH) and/or olefin copolymer fibers (F-OC) in a certain level.

Thus, it is appreciated that the amount of olefin homopolymer fibers (F-OH) and/or olefin copolymer fibers (F-OC) within the fiber-reinforced composite (FR-C) is within the range of 0.1 to 50 wt.-%, based on the total weight of the fiber-reinforced composite (FR-C). Accordingly, it is preferred that the fiber-reinforced composite (FR-C) of the present invention comprises the matrix (M) in an amount of from 50 to 99.9 wt.-%, based on the total weight of the fiber-reinforced composite (FR-C).

In one embodiment of the present invention, the fiber-reinforced composite (FR-C) thus comprises
a) from 50 to 99.9 wt.-% of the matrix (M), and
b) from 0.1 to 50 wt.-% of olefin homopolymer fibers (F-OH) and/or olefin copolymer fibers (F-OC), based on the total weight of the fiber-reinforced composite (FR-C).

For example, the fiber-reinforced composite (FR-C) comprises
a) from 70 to 99.5 wt.-% of the matrix (M), and
b) from 0.5 to 30 wt.-% of olefin homopolymer fibers (F-OH) and/or olefin copolymer fibers (F-OC), based on the total weight of the fiber-reinforced composite (FR-C).

Alternatively, the fiber-reinforced composite (FR-C) comprises
a) from 80 to 99.0 wt.-% of the matrix (M), and
b) from 1.0 to 20 wt.-% of olefin homopolymer fibers (F-OH) and/or olefin copolymer fibers (F-OC), based on the total weight of the fiber-reinforced composite (FR-C).

In accordance with the present invention, the fiber-reinforced composite (FR-C) comprises a matrix (M) comprising a polypropylene (PP).

The term “matrix” in the meaning of the present invention is to be interpreted in its commonly accepted meaning, i.e. it refers to a continuous phase (in the present invention a continuous polymer phase) in which isolated or discrete particles such as olefin homopolymer fibers (F-OH) and/or olefin copolymer fibers (F-OC) are dispersed. The matrix (M) is present in such an amount so as to form a continuous phase which can act as a matrix.

The fiber-reinforced composite (FR-C) of the present invention may comprise further components. Preferably the fiber-reinforced composite (FR-C) according to this invention does not comprise more than 10 wt.-%, more preferably not more than 5 wt.-%, based on the amount of the fiber-reinforced composite (FR-C) of fibres other than the olefin homopolymer fibers (F-OH) and/or olefin copolymer fibers (F-OC) as defined in the instant invention. Accordingly in one preferred embodiment the instant fiber-reinforced composite (FR-C) comprises as fibres only the olefin homopolymer fibers (F-OH) and/or olefin copolymer fibers (F-OC). Further it is preferred that the fiber-reinforced composite (FR-C) comprises as polymer components only the matrix (M) and olefin homopolymer fibers (F-OH) and/or olefin copolymer fibers (F-OC) dispersed in said matrix (M) as defined in the instant invention. Accordingly, the amounts of the matrix (M) and olefin homopolymer fibers (F-OH) and/or olefin copolymer fibers (F-OC) dispersed in said matrix (M) may not result in 100 wt.-% based on the total fiber-reinforced composite (FR-C). Thus the remaining part up 100 wt.-% may be accomplished by further additives or other fibres known in the art. However, this remaining part shall be not more than 10 wt.-%, more preferably not more than 5 wt.-%, like not more than 3 wt.-%, like not more than 1 wt.-% within the total fiber-reinforced composite (FR-C). For instance, the inventive fiber-reinforced composite (FR-C) may comprise additionally small amounts of talc, antioxidants stabilizers, fillers, colorants, nucleating agents and antistatic agents.

As mentioned above the fiber-reinforced composite (FR-C) can comprise up to 10 wt.-%, preferably up to 5 wt.-%, fibres other than olefin homopolymers (F-OH) and/or olefin copolymers (F-OC). However in a preferred embodiment the fiber-reinforced composite (FR-C) only comprises fibers based on olefin homopolymers (F-OH) and/or olefin copolymers (F-OC). In other words, the fiber-reinforced composite (FR-C) does not comprise fibers typically found in fiber-reinforced materials, like glass fibers, carbon fibers, aramid fibers, metal fibers, ceramic fibers, graphite fibers, wollastonite fibre, and mixture thereof. Thus in one preferred embodiment the fiber-reinforced composite (FR-C) is free of any fibers being not polymer fibers, preferably being not polyolefin fibers, more preferably being not the olefin homopolymer fibers (F-OH) and/or olefin copolymer fibers (F-OC) according to the instant invention. Accordingly, the matrix (M) and the olefin homopolymer fibers (F-OH) and/or olefin copolymer fibers (F-OC) dispersed in said matrix (M) preferably constitute together at least 90 wt.-%, more preferably at least 95 wt.-%, still more preferably at least to 97 wt.-%, yet more preferably at least 99 wt.-%, to the total fiber-reinforced composite (FR-C).

In one embodiment of the present invention, the polypropylene (PP) being present in the matrix (M) is a propylene homopolymer (H-PP1) and/or a propylene copolymer (C-PP1). For example, the matrix (M) comprises a propylene homopolymer (H-PP1) and a propylene copolymer (C-PP1). Alternatively, the matrix (M) comprises a propylene homopolymer (H-PP1) or a propylene copolymer (C-PP1). Preferably the amount of the polypropylene (PP) in the matrix (M) is at least 50 wt.-%, more preferably at least 70 wt.-%, still more preferably at least 85 wt.-%, yet more preferably at least 95 wt.-%, like at least 97 wt.-% or 99 wt.-% based on the total amount of the matrix (M). In one embodiment the matrix (M) consists of the polypropylene (PP), e.g. consists of the propylene homopolymer (H-PP1) and/or a propylene copolymer (C-PP1).

In one specific embodiment the polypropylene (PP) is a propylene copolymer (C-PP1), preferably a heterophasic propylene copolymer (HECO) as defined in detail below.

In the following the matrix (M) and the polypropylene (PP) being part of the matrix (M) will be defined in more detail.

The matrix (M) of the fiber-reinforced composite (FR-C) comprises a propylene homopolymer (H-PP1) and/or a propylene copolymer (C-PP1) of a certain melt flow rate, which in turn mainly influences the melt flow rate of the matrix (M). Accordingly, it is preferred that in the present invention the matrix (M) and/or the polypropylene (PP), i.e. the propylene homopolymer (H-PP1) and/or a propylene copolymer (C-PP1), e.g. the heterophasic propylene copolymer (HECO), has a melt flow rate MFR₂ (230° C.) of from 1 to 500 g/10 min, more preferably of from 2 to 300 g/10 min, still more preferably of from 5 to 100 g/10 min and most preferably of from 8 to 80 g/10 min.

Preferably, the polypropylene (PP), i.e. the propylene homopolymer (H-PP1) and/or the propylene copolymer (C-PP1), e.g. the heterophasic propylene copolymer (HECO), has a melting temperature Tm of below 175° C., more preferably of below 170° C., like of equal or below 168° C. For example, the melting temperature ranges from 130 to 175° C., more preferably ranges from 140 to 170° C. and most preferably ranges from 150 to 168° C.

In one embodiment of the present invention, the polypropylene (PP) is a propylene homopolymer (H-PP1).

The expression propylene homopolymer as used throughout the instant invention relates to a polypropylene that consists substantially, i.e. of more than 99.5 wt.-%, still more preferably of at least 99.7 wt.-%, like of at least 99.8 wt.-%, of propylene units. In a preferred embodiment only propylene units in the propylene homopolymer are detectable.

Preferably, the propylene homopolymer (H-PP1) has a melting temperature Tm in the range of 150 to 175° C., more preferably in the range of 155 to 170° C. and most preferably in the range of 158 to 168° C.

The propylene homopolymer (H-PP1) is preferably an isotactic propylene homopolymer. Accordingly, it is appreciated that the polypropylene matrix (H-PP1) has a rather high isotactic pentad concentration, i.e. higher than 90 mol-%, more preferably higher than 92 mol-%, still more preferably higher than 93 mol-% and yet more preferably higher than 95 mol-%, like higher than 97 mol-%.

Furthermore, the propylene homopolymer (H-PP1) preferably has a xylene cold soluble content (XCS) of not more than 5 wt.-%, more preferably in the range of 0.1 to 3.5 wt.-%, still more preferably in the range of 0.5 to 2.5 wt.-%.

Concerning the melt flow rate MFR₂ (230° C.) of the propylene homopolymer (H-PP1) reference is made to the information provided above.

The propylene homopolymer (H-PP1) may be produced in the presence of a single-site catalyst, e.g. a metallocene catalyst, or in the presence of a Ziegler-Natta catalyst. The propylene homopolymer (H-PP1) is commercially available and known to the skilled person.

In case the propylene homopolymer (H-PP1) is the main component in the matrix (M), i.e. in the amounts defined above, the matrix (M) has the same properties as the propylene homopolymer (H-PP1).

In another and preferred embodiment of the present invention, the polypropylene (PP) is a propylene copolymer (C-PP1).

The term “propylene copolymer (C-PP1)” covers random propylene copolymers (RC-PP1) as well as complex structures, like heterophasic systems.

The term “random propylene copolymer” indicates that the comonomers within the propylene copolymer (C-PP1) are randomly distributed. The randomness defines the amount of isolated comonomer units, i.e. those which have no neighbouring comonomer units, compared to the total amount of comonomers in the polymer chain. In a preferred embodiment, the randomness of the random propylene copolymer (RC-PP1) is at least 30%, more preferably at least 50%, even more preferably at least 60%, and still more preferably at least 65%, based on the total weight of the random propylene copolymer (RC-PP1).

Accordingly the expression “random propylene copolymer” according to the present invention does not define a polymer of complex structures but a one phase system in contrast to a heterophasic system. Accordingly the expression “random propylene copolymer” defines a polymer which backbone or its side chains contains to some extent α-olefins other than propylene.

Thus the random propylene copolymer (RC-PP1) preferably comprises, preferably consist of, units derived from
(i) propylene and
(ii) ethylene and/or at least one C₄ to C₂₀ α-olefin, preferably at least one α-olefin selected from the group consisting of ethylene, 1-butene, 1-pentene, 1-hexene and 1-octene, more preferably ethylene and/or 1-butene, yet more preferably ethylene.

Accordingly, the random propylene copolymer (RC-PP1) may comprise units derived from propylene, ethylene and optionally at least another C₄ to C₁₀ α-olefin. In one embodiment of the present invention, the random propylene copolymer (RC-PP1) comprises units derived from propylene, ethylene and optionally at least another α-olefin selected from the group consisting of C₄ α-olefin, C₅ α-olefin, C₆ α-olefin, C₇ α-olefin, C₈ α-olefin, C₉ α-olefin and C₁₀ α-olefin. More preferably the random propylene copolymer (RC-PP1) comprises units derived from propylene, ethylene and optionally at least another α-olefin selected from the group consisting of 1-butene, 1-pentene, 1-hexene, 1-heptene, 1-octene, 1-nonene and 1-decene, wherein 1-butene and 1-hexene are preferred. It is in particular preferred that the random propylene copolymer (RC-PP1) consists of units derived from propylene and ethylene. Preferably, the units derivable from propylene constitutes the main part of the propylene copolymer (C-PP1), i.e. at least 80 wt.-%, more preferably of at least 85 wt.-%, still more preferably of 80 to 99.5 wt.-%, yet more preferably of 85 to 99.5 wt.-%, still more preferably of 90 to 99.2 wt.-%, based on the total weight of the random propylene copolymer (RC-PP1). Accordingly, the amount of units derived from C₂ to C₂₀ α-olefins other than propylene in the random propylene copolymer (RC-PP1) is in the range of 0.5 to 20 wt.-%, more preferably of 0.5 to 15 wt.-%, still more preferably of 0.8 to 10 wt.-%, based on the total weight of the random propylene copolymer (RC-PP1). It is in particular appreciated that the amount of ethylene in the random propylene copolymer (RC-PP1), in particular in case the random propylene copolymer (RC-PP1) comprises only units derivable from propylene and ethylene, is in the range of 0.5 to 20 wt.-%, preferably of 0.8 to 15 wt.-%, more preferably of 0.8 to 10 wt.-%, based on the total weight of the random propylene copolymer (RC-PP1).

Preferably, the random propylene copolymer (RC-PP1) is isotactic. Accordingly, it is appreciated that the random propylene copolymer (RC-PP1) has a rather high pentad concentration, i.e. higher than 95 mol-%, more preferably higher than 97 mol-%, still more preferably higher than 98 mol-%.

Additionally, it is appreciated that the random propylene copolymer (RC-PP1) has a melting temperature Tm in the range of 125 to 165° C., more preferably ranges from 130 to 158° C. and most preferably ranges from 135 to 150° C.

Concerning the melt flow rate MFR₂ (230° C.) of the random propylene copolymer (RC-PP1) reference is made to the information provided above.

In case the random propylene copolymer (RC-PP1) is the main component in the matrix (M), i.e. in the amounts defined above, the matrix (M) has the same properties as the random propylene copolymer (RC-PP1).

In one specific embodiment of the present invention, the polypropylene (PP) is a heterophasic propylene copolymer (HECO). Accordingly the matrix (M) preferably comprises at least 50 wt.-%, more preferably at least 70 wt.-%, still more preferably at least 85 wt.-%, yet more preferably at least 95 wt.-%, like at least 97 wt.-% or 99 wt.-% of a heterophasic propylene copolymer (HECO). In one embodiment the matrix (M) consists of a heterophasic propylene copolymer (HECO).

In the following the heterophasic propylene copolymer (HECO) is defined in more detail.

Preferably the heterophasic propylene copolymer (HECO) comprises
a) a polypropylene matrix (M-HECO), and
b) an elastomeric propylene copolymer (E).

The expression “heterophasic” indicates that the elastomeric copolymer (E) is preferably (finely) dispersed at least in the polypropylene matrix (M-HECO) of the heterophasic propylene copolymer (M-HECO). In other words the elastomeric copolymer (E) forms inclusions in the polypropylene matrix (M-HECO). Thus, the polypropylene matrix (M-HECO) contains (finely) dispersed inclusions being not part of the matrix and said inclusions contain the elastomeric copolymer (E). The term “inclusion” according to this invention shall preferably indicate that the matrix and the inclusion form different phases within the heterophasic propylene copolymer (M-HECO), said inclusions are for instance visible by high resolution microscopy, like electron microscopy or scanning force microscopy.

Furthermore, the heterophasic propylene copolymer (HECO) preferably comprises as polymer components only the polypropylene matrix (M-HECO) and the elastomeric copolymer (E). In other words the heterophasic propylene copolymer (HECO) may contain further additives but no other polymer in an amount exceeding 5 wt-%, more preferably exceeding 3 wt.-%, like exceeding 1 wt.-%, based on the total heterophasic propylene copolymer (HECO), more preferably based on the polymers present in the heterophasic propylene copolymer (HECO). One additional polymer which may be present in such low amounts is a polyethylene which is a reaction product obtained by the preparation of the heterophasic propylene copolymer (HECO). Accordingly, it is in particular appreciated that a heterophasic propylene copolymer (HECO) as defined in the instant invention contains only a polypropylene matrix (M-HECO), an elastomeric copolymer (E) and optionally a polyethylene in amounts as mentioned in this paragraph.

The elastomeric copolymer (E) is preferably an elastomeric ethylene copolymer (E1) and/or an elastomeric propylene copolymer (E2), the latter being preferred.

As explained above a heterophasic propylene copolymer (HECO) comprises a polypropylene matrix (M-HECO) in which the elastomeric propylene copolymer (E) is dispersed.

The polypropylene matrix (M-HECO) can be a propylene homopolymer (H-PP2) or a propylene copolymer (C-PP2).

However, it is preferred that the propylene matrix (M-HECO) is a propylene homopolymer (H-PP2).

The polypropylene matrix (M-HECO) being a propylene homopolymer (H-PP2) is preferably an isotactic propylene homopolymer. Accordingly it is appreciated that the propylene homopolymer (H-PP2) has a rather high pentad concentration, i.e. higher than 90 mol-%, more preferably higher than 92 mol-%, still more preferably higher than 93 mol-% and yet more preferably higher than 95 mol-%, like higher than 99 mol-%.

The polypropylene matrix (M-HECO) being a propylene homopolymer (H-PP2) has a rather low xylene cold soluble (XCS) content, i.e. of not more than 3.5 wt.-%, preferably of not more than 3.0 wt.-%, like not more than 2.6 wt.-%, based on the total weight of the polypropylene matrix (M-HECO). Thus, a preferred range is 0.5 to 3.0 wt.-%, more preferred 0.5 to 2.5 wt.-%, still more preferred 0.7 to 2.0 wt.-% and most preferred 0.7 to 1.5 wt.-%, based on the total weight of the propylene homopolymer (H-PP2).

In one embodiment of the present invention, the polypropylene matrix (M-HECO) is a propylene homopolymer (H-PP2) having a melt flow rate MFR₂ (230° C.) from 1 to 500 g/10 min, more preferably of from 2 to 300 g/10 min, still more preferably of from 5 to 100 g/10 min and most preferably of from 8 to 80 g/10 min.

Preferably, the propylene homopolymer (H-PP2) has a melting temperature Tm in the range of 150 to 175° C., more preferably in the range of 155 to 170° C. and most preferably in the range of 158 to 168° C.

If the polypropylene matrix (M-HECO) is a propylene copolymer (C-PP2), the propylene copolymer (C-PP2) preferably comprises, preferably consist of, units derived from
(i) propylene and
(ii) ethylene and/or at least one C₄ to C₈ α-olefin, preferably at least one α-olefin selected from the group consisting of ethylene, 1-butene, 1-pentene, 1-hexene and 1-octene, more preferably ethylene and/or 1-butene, yet more preferably ethylene.

Accordingly, the propylene copolymer (C-PP2) may comprise units derived from propylene, ethylene and optionally at least another C₄ to C₈ α-olefin. In one embodiment of the present invention the propylene copolymer (C-PP2) comprises units derived from propylene, ethylene and optionally at least another α-olefin selected from the group consisting of C₄ α-olefin, C₅ α-olefin, C₆ α-olefin, C₇ α-olefin, C₈ α-olefin. More preferably the propylene copolymer (C-PP2) comprises units derived from propylene, ethylene and optionally at least another α-olefin selected from the group consisting of 1-butene, 1-pentene, 1-hexene, 1-heptene, 1-octene, wherein 1-butene and 1-hexene are preferred. It is in particular preferred that the propylene copolymer (C-PP2) consists of units derived from propylene and ethylene. Preferably, the units derivable from propylene constitutes the main part of the propylene copolymer (C-PP2), i.e. at least 95 wt.-%, preferably of at least 97 wt.-%, more preferably of at least 98 wt.-%, still more preferably of 95 to 99.5 wt.-%, yet more preferably of 97 to 99.5 wt.-%, still more preferably of 98 to 99.2 wt.-%, based on the total weight of the propylene copolymer (C-PP2). The amount of units derived from C₂ to C₈ α-olefins other than propylene in the propylene copolymer (C-PP2), is in the range of 0.5 to 5 wt.-%, more preferably 0.5 to 3 wt.-%, still more preferably 0.8 to 2 wt.-%, based on the total weight of the propylene copolymer (C-PP2). It is in particular appreciated that the amount of ethylene in the propylene copolymer (C-PP2), in particular in case the propylene copolymer comprises only units derivable from propylene and ethylene, is in the range of 0.5 to 5 wt.-%, preferably of 0.8 to 2 wt.-%, based on the total weight of the propylene copolymer (C-PP2).

Furthermore, it is appreciated that the xylene cold soluble (XCS) content of the polypropylene matrix (M-HECO) being a propylene copolymer (C-PP2) is a rather low. Accordingly, the propylene copolymer (C-PP2) has preferably a xylene cold soluble (XCS) fraction measured according to ISO 6427 (23° C.) of not more than 14 wt-%, more preferably of not more than 13 wt.-%, yet more preferably of not more than 12 wt.-%, like not more than 11.5 wt.-%, based on the total weight of the propylene copolymer (C-PP2). Thus, a preferred range is 1 to 14 wt.-%, more preferred 1.0 to 13 wt.-%, still more preferred 1.2 to 11 wt.-%, based on the total weight of the propylene copolymer (C-PP2).

Preferably, the polypropylene matrix (M-HECO) being a propylene copolymer (C-PP2) is isotactic. Accordingly, it is appreciated that the propylene copolymer (C-PP2) has a rather high pentad concentration, i.e. higher than 95 mol-%, more preferably higher than 97 mol-%, still more preferably higher than 98 mol-%.

Furthermore, it is appreciated that the units derived from C₂ to C₈ α-olefins other than propylene within the propylene copolymer (C-PP2) are randomly distributed. The randomness indicates the amount of isolated comonomer units, i.e. those which have no other comonomer units in the neighbourhood, compared to the total amount of comonomers in the polymer chain. In a preferred embodiment, the randomness of the propylene copolymer (C-PP2) is at least 30%, more preferably at least 50%, even more preferably at least 60%, and still more preferably at least 65%.

Additionally, it is appreciated that the random propylene copolymer (C-PP2) has a melting temperature Tm in the range of 125 to 165° C., more preferably ranges from 130 to 158° C. and most preferably ranges from 135 to 150° C.

In one embodiment of the present invention, the random propylene copolymer (C-PP2) has a melt flow rate MFR₂ (230° C.) from 1 to 500 g/10 min, more preferably of from 2 to 300 g/10 min, still more preferably of from 5 to 100 g/10 min and most preferably of from 8 to 80 g/10 min.

The second component of the heterophasic propylene copolymer (HECO) is the elastomeric copolymer (E). As mentioned above the elastomeric copolymer (E) can be an elastomeric ethylene copolymer (E1) and/or an elastomeric propylene copolymer (E2). In the following both elastomers are defined more precisely.

Preferably the elastomeric ethylene copolymer (E1) comprises units derived from (i) ethylene and (ii) propylene and/or C₄ to C₂₀ α-olefins, preferably from (i) ethylene and (ii) selected from the group consisting of propylene, 1-butene, 1-hexene, and 1-octene.

Preferably the ethylene content in the elastomeric ethylene copolymer (E1) is at least 50 wt.-%, more preferably at least 60 wt.-%. Thus in one preferred embodiment the elastomeric ethylene copolymer (E1) comprises 50.0 to 85.0 wt.-%, more preferably 60.0 to 78 wt.-%, units derivable from ethylene. The comonomers present in the elastomeric ethylene copolymer (E1) are preferably C₄ to C₂₀ α-olefins, like 1-butene, 1-hexene and 1-octene, the latter especially preferred. Accordingly in one specific embodiment elastomeric ethylene copolymer (E1) is an ethylene-1-octene polymer with the amounts given in this paragraph.

In turn the elastomeric propylene copolymer (E2) preferably comprises units derived from (i) propylene and (ii) ethylene and/or C₄ to C₈ α-olefin. Accordingly the elastomeric propylene copolymer (E2) comprises, preferably consists of, units derivable from (i) propylene and (ii) ethylene and/or at least another C₄ to C₆ α-olefin, more preferably units derivable from (i) propylene and (ii) ethylene and at least another α-olefin selected form the group consisting of 1-butene, 1-pentene, 1-hexene, 1-heptene and 1-octene. The elastomeric propylene copolymer (E2) may additionally contain units derived from a non-conjugated diene, however it is preferred that the elastomeric propylene copolymer (E2) consists of units derivable from (i) propylene and (ii) ethylene and/or C₄ to C₈ α-olefins only. Suitable non-conjugated dienes, if used, include straight-chain and branched-chain acyclic dienes, such as 1,4-hexadiene, 1,5-hexadiene, 1,6-octadiene, 5-methyl-1,4-hexadiene, 3,7-dimethyl-1,6-octadiene, 3,7-dimethyl-1,7-octadiene, and the mixed isomers of dihydromyrcene and dihydro-ocimene, and single ring alicyclic dienes such as 1,4-cyclohexadiene, 1,5-cyclooctadiene, 1,5-cyclododecadiene, 4-vinyl cyclohexene, 1-allyl-4-isopropylidene cyclohexane, 3-allyl cyclopentene, 4-cyclohexene and 1-isopropenyl-4-(4-butenyl)cyclohexane. Multi-ring alicyclic fused and bridged ring dienes are also suitable including tetrahydroindene, methyltetrahydroindene, dicyclopentadiene, bicyclo(2,2,1) hepta-2,5-diene, 2-methyl bicycloheptadiene, and alkenyl, alkylidene, cycloalkenyl and cycloalkylidene norbornenes, such as 5-methylene-2-norbornene, 5-isopropylidene norbornene, 5-(4-cyclopentenyl)-2-norbornene; and 5-cyclohexylidene-2-norbornene. Preferred non-conjugated dienes are 5-ethylidene-2-norbornene, 1,4-hexadiene and dicyclopentadiene.

Accordingly, the elastomeric propylene copolymer (E2) comprises at least units derivable from propylene and ethylene and may comprise other units derivable from a further α-olefin as defined in the previous paragraph. However, it is in particular preferred that the elastomeric propylene copolymer (E2) comprises units only derivable from propylene and ethylene and optionally a non-conjugated diene as defined in the previous paragraph, like 1,4-hexadiene. Thus, an ethylene propylene non-conjugated diene monomer polymer (EPDM) and/or an ethylene propylene rubber (EPR) as elastomeric propylene copolymer (E2) is especially preferred, the latter most preferred.

In one embodiment of the present invention, the elastomeric propylene copolymer (E2) is an ethylene propylene rubber (EPR).

Preferably the amount of propylene in the elastomeric propylene copolymer (E2) ranges from 50 to 75 wt.-%, more preferably 55 to 70 wt.-%. Thus, in a specific embodiment the elastomeric propylene copolymer (E2) comprises from 25 to 50 wt.-%, more preferably 30 to 45 wt.-%, units derivable from ethylene. Preferably, the elastomeric propylene copolymer (E2) is an ethylene propylene non-conjugated diene monomer polymer (EPDM1) or an ethylene propylene rubber (EPR), the latter especially preferred, with a propylene and/or ethylene content as defined in this paragraph.

The intrinsic viscosity (IV) of the xylene cold soluble (XCS) fraction of the heterophasic propylene copolymer (HECO) is preferably moderate. Accordingly, it is appreciated that the intrinsic viscosity of the xylene cold soluble (XCS) fraction of the heterophasic propylene copolymer (HECO) is below 3.3 dl/g, more preferably below 3.1 dl/g, and most preferably below 3.0 dl/g. Even more preferred the intrinsic viscosity of the xylene cold soluble (XCS) fraction of the heterophasic propylene copolymer (HECO) is in the range of 1.5 to 3.3 dug, more preferably in the range 2.0 to 3.1 dug, still more preferably 2.2 to 3.0 dug.

It is especially preferred that heterophasic propylene copolymer (HECO) comprises a propylene homopolymer (H-PP2) as the polypropylene matrix (M-HECO) and an ethylene propylene rubber (EPR1) as the elastomeric propylene copolymer (E2).

Preferably, the heterophasic propylene copolymer (HECO) has a melt flow rate MFR₂ (230° C.) of from 1 to 300 g/10 min, more preferably of from 2 to 100 g/10 min, still more preferably of from 3 to 80 g/10 min, yet more preferably of from 4 to 40 g/10 min, like in the range of 5 to 30 g/10 min.

Preferably, the heterophasic propylene copolymer (HECO) has a melting temperature Tm in the range of 150 to 175° C., more preferably in the range of 155 to 170° C. and most preferably in the range of 158 to 168° C.

Preferably the amount of the heterophasic propylene copolymer (HECO) in the matrix (M) is at least 50 wt.-%, more preferably at least 70 wt.-%, still more preferably at least 85 wt.-%, yet more preferably at least 95 wt.-%, like at least 97 wt.-% or 99 wt.-% based on the total amount of the matrix (M). In one embodiment the matrix (M) consists of the heterophasic propylene copolymer (HECO.

A further essential component of the present fiber-reinforced composite (FR-C) are the fibers (F). It is one requirement of the present invention that the fibers (F) are olefin homopolymer fibers (F-OH) and/or olefin copolymer fibers (F-OC).

The olefin homopolymer fibers (F-OH) and/or olefin copolymer fibers (F-OC) preferably have a melting temperature in the range of 125 to 170° C., more preferably in the range of 130 to 168° C.

For example, the fiber-reinforced composition (FR-C) comprises olefin homopolymer fibers (F-OH) and olefin copolymer fibers (F-OC). Alternatively, the fiber-reinforced composition (FR-C) comprises olefin homopolymer fibers (F-OH) or olefin copolymer fibers (F-OC).

In one embodiment of the present invention, the fibers (F) dispersed in the matrix (M) of the fiber-reinforced composite (FR-C) are olefin homopolymer fibers (F-OH).

According to the present invention, olefin homopolymer fibers (F-OH) can be ethylene homopolymer fibers (F-EH) and/or propylene homopolymer fibers (F-PH). Additionally or alternatively, olefin copolymer fibers (F-OC) can be ethylene copolymer fibers (F-EC) and/or propylene homopolymer fibers (F-PC).

In one embodiment of the present invention, the olefin homopolymer fibers (F-OH) are ethylene homopolymer fibers (F-EH) and/or ethylene copolymer fibers (F-EC).

The expression ethylene homopolymer fibers (F-EH) used in the instant invention relates to polyethylene fibers comprising a polyethylene that consist substantially, i.e. of more than 99.7 wt.-%, still more preferably of at least 99.8 wt.-%, of ethylene units. In a preferred embodiment only ethylene units in the ethylene homopolymer fibers (F-EH) are detectable.

In case the fibers are ethylene copolymer fibers (F-EC), it is preferred that they contain as a major part units derivable from ethylene. Accordingly, it is appreciated that the ethylene copolymer fibers (F-EC) comprise at least 55 wt.-% units derivable from ethylene, more preferably at least 60 wt.-% of units derived from ethylene, based on the total weight of the ethylene copolymer fibers (F-EC). Thus, it is appreciated that the ethylene copolymer fibers (F-EC) comprise 60 to 99.5 wt.-%, more preferably 90 to 99 wt.-%, units derivable from ethylene, based on the total weight of the ethylene copolymer fibers (F-EC). The comonomers present in such ethylene copolymer fibers (F-EC) are propylene and/or C₄ to C₂₀ α-olefins, like 1-butene, 1-hexene and 1-octene, the latter especially preferred, or dienes, preferably non-conjugated α,ω-alkadienes, i.e. C₅ to C₂₀ α,ω-alkadienes, like 1,7-octadiene.

In one embodiment of the present invention, the ethylene homopolymer fibers (F-EH) and/or ethylene copolymer fibers (F-EC) are selected from HDPE, LDPE, LLDPE, VLDPE, ULDPE and other polymers or copolymers containing ethylene and another α-olefin.

The ethylene homopolymer fibers (F-EH) and/or ethylene copolymer fibers (F-EC) preferably have a melting temperature in the range of 125 to 150° C., more preferably in the range of 130 to 145° C.

In one embodiment of the present invention, the fibers are propylene homopolymer fibers (F-PH) and/or propylene copolymer fibers (F-PC).

Preferably, the propylene homopolymer fibers (F-PH) and propylene copolymer fibers (F-PC) have a melting temperature Tm of below 175° C., more preferably of below 170° C., like of equal or below 168° C. For example, the melting temperature ranges from 130 to 175° C., more preferably ranges from 140 to 170° C. and most preferably ranges from 150 to 168° C.

The expression propylene homopolymer fibers (F-PH) as used throughout the instant invention relates to a polypropylene fibers that consists substantially, i.e. of more than 99.5 wt.-%, still more preferably of at least 99.7 wt.-%, like of at least 99.8 wt.-%, of propylene units. In a preferred embodiment only propylene units in the propylene homopolymer fibers (F-PH) are detectable.

The propylene homopolymer fibers (F-PH) preferably have a melting temperature Tm in the range of 150 to 175° C., more preferably in the range of 155 to 170° C. and most preferably in the range of 158 to 168° C.

In case the fibers are propylene copolymer fibers (F-PC), it is preferred that they contain as a major part units derivable from propylene. Accordingly, the propylene copolymer fibers (F-PC) may comprise units derived from propylene, ethylene and optionally at least another C₄ to C₁₀ α-olefin. In one embodiment of the present invention, the propylene copolymer fibers (F-PC) comprise units derived from propylene, ethylene and optionally at least another α-olefin selected from the group consisting of C₄ α-olefin, C₅ α-olefin, C₆ α-olefin, C₇ α-olefin, C₈ α-olefin, C₉ α-olefin and C₁₀ α-olefin. More preferably the propylene copolymer fibers (F-PC) comprise units derived from propylene, ethylene and optionally at least another α-olefin selected from the group consisting of 1-butene, 1-pentene, 1-hexene, 1-heptene, 1-octene, 1-nonene and 1-decene, wherein 1-butene and 1-hexene are preferred. It is in particular preferred that the propylene copolymer fibers (F-PC) consist of units derived from propylene and ethylene. Preferably, the units derivable from propylene constitutes the main part of the, i.e. at least 95 wt.-%, preferably of at least 97 wt.-%, more preferably of at least 98 wt.-%, still more preferably of 95 to 99.5 wt.-%, yet more preferably of 97 to 99.5 wt.-%, still more preferably of 98 to 99.2 wt.-%, based on the total weight of the propylene copolymer fibers (F-PC). The amount of units derived from C₂ to C₂₀ α-olefins other than propylene in the propylene copolymer fibers (F-PC), is in the range of 0.5 to 5 wt.-%, more preferably 0.5 to 3 wt.-%, still more preferably 0.8 to 2.0 wt.-%, based on the total weight of the propylene copolymer fibers (F-PC). It is in particular appreciated that the amount of ethylene in the propylene copolymer fibers (F-PC), in particular in case the propylene copolymer fibers (F-PC) comprise only units derivable from propylene and ethylene, is in the range of 0.5 to 5 wt.-%, preferably of 0.8 to 2 wt.-%, based on the total weight of the propylene copolymer fibers (F-PC).

The propylene copolymer fibers (F-PC) preferably have a melting temperature Tm in the range of 125 to 165° C., more preferably ranges from 130 to 158° C. and most preferably ranges from 135 to 150° C.

In one especially preferred embodiment of the present invention, the fibers are propylene homopolymer fibers (F-PH).

The olefin homopolymer fibers (F-OH) and/or olefin copolymer fibers (F-OC) of the present invention may be used in various forms and shapes. For example, the olefin homopolymer fibers (F-OH) and/or olefin copolymer fibers (F-OC) may be either cut fibers or long (continuous) fibers, although preference is given to using long fibers. In general, the olefin homopolymer fibers (F-OH) and/or olefin copolymer fibers (F-OC) can have a length of at least 1 mm. The cut fibers used in the fiber-reinforced composite (FR-C) preferably have a length of from 1 to 40 mm, more preferably from 5 to 30 mm, and/or an average diameter of from 5 to 25 μm, more preferably from 10 to 20 μm. If long (continuous) fibers are used in the fiber-reinforced composite (FR-C), the fibers are preferably fibers having an average diameter of from 5 to 50 μm, more preferably from 10 to 25 μm.

Preferably, the cut olefin homopolymer fibers (F-OH) and/or cut olefin copolymer fibers (F-OC) may have an aspect ratio of 150 to 450, more preferably 200 to 400, still more preferably 250 to 350.

In one embodiment of the present invention, the olefin homopolymer fibers (F-OH) and/or olefin copolymer fibers (F-OC) are in the form of fiber bundles, preferably if the olefin homopolymer fibers (F-OH) and/or olefin copolymer fibers (F-OC) are long (continuous) fibers. Accordingly, the olefin homopolymer fibers (F-OH) and/or olefin copolymer fibers (F-OC) are preferably in the form of continuous fiber bundles.

The number of olefin homopolymer fibers (F-OH) and/or olefin copolymer fibers (F-OC) in a fiber bundle, preferably continuous fiber bundle, varies depending on the strength and stiffness requirements of the final application.

Continuous fiber bundles of the olefin homopolymer fibers (F-OH) and/or olefin copolymer fibers (F-OC) can be woven into a fabric or incorporated into unidirectional continuous fiber straps. The long (continuous) fibers or continuous fiber bundles can be cut into non-continuous fibers or fiber bundles and incorporated into a non-woven fabric such as a matt fabric. Such cut fibers, of uniform or random length, can be dispersed into the matrix (M) during an extrusion process.

Preferably the olefin homopolymer fibers (F-OH) and/or olefin copolymer fibers (F-OC) of the instant fiber-reinforced composite (FR-C), especially if they are in the form of long (continuous) fibers and/or fiber bundles, are impregnated with the matrix (M) consisting of a polypropylene (PP). In other words the fiber-reinforced composite (FR-C) is preferably not obtained by an process in which the fibers and the polypropylene (PP) are extruded. Rather the polypropylene (PP) is molten, preferably by known extrusion techniques, and subsequently said molten polypropylene (PP) embeds the fibers, i.e. the olefin homopolymer fibers (F-OH) and/or olefin copolymer fibers (F-OC).

Thus, in a further aspect of the present invention a process for the preparation of the fiber-reinforced composite (FR-C) as defined above is provided, the process comprising the steps of
a) providing a molten polypropylene (PP),
b) providing the olefin homopolymer fibers (F-OH) and/or olefin copolymer fibers (F-OC),
c) impregnating the olefin homopolymer fibers (F-OH) and/or olefin copolymer fibers (F-OC) of step b) with the molten polypropylene of step a) such as to obtain said fiber-reinforced composite (FR-C).

The impregnation of the olefin homopolymer fibers (F-OH) and/or olefin copolymer fibers (F-OC) of step b) with the matrix (M) of step a) can be accomplished by any conventional means known to the skilled person. The skilled person will adapt the impregnation conditions such as the impregnation speed and temperature according to his process equipment.

Preferably, the impregnation may be carried out such that the obtained fiber-reinforced composite (FR-C) comprises individual fibers which are surrounded by the matrix (M) consisting of a polypropylene (PP).

In one embodiment of the present invention, impregnating step c) is carried out such that the polypropylene (PP) is molten and/or the olefin homopolymer fibers (F-OH) and/or olefin copolymer fibers (F-OC) are substantially in solid form.

In particular, it is to be noted that the olefin homopolymer fibers (F-OH) and/or olefin copolymer fibers (F-OC) are substantially in solid form. That is to say, the temperature during impregnating step c) is adjusted such that the olefin homopolymer fibers (F-OH) and/or olefin copolymer fibers (F-OC) are not completely molten. Accordingly, it is appreciated that the term “substantially in solid form” does not exclude that the olefin homopolymer fibers (F-OH) and/or olefin copolymer fibers (F-OC) are partially molten, e.g. the surface of the olefin homopolymer fibers (F-OH) and/or olefin copolymer fibers (F-OC).

However, it is one requirement of the present invention that the olefin homopolymer fibers (F-OH) and/or olefin copolymer fibers (F-OC) and the polypropylene (PP) form different phases within the fiber-reinforced composite (FR-C).

The instant composition may additional contain typical other additives useful for instance in the automobile sector, like carbon black, other pigments, antioxidants, UV stabilizers, nucleating agents, antistatic agents and slip agents, in amounts usual in the art.

All components used for the preparation of the instant fiber-reinforced composite (FR-C) are known. Accordingly also their preparations are well known.

According to a further aspect, the present invention relates to an automotive article comprising the fiber-reinforced composite (FR-C) as defined above. More preferably the automotive article comprises at least 50 wt.-%, more preferably at least 75 wt.-%, still more preferably at least 95 wt.-%, yet more preferably consist, of the fiber-reinforced composite (FR-C) as defined above. It is preferred that the automotive article is an exterior or interior automotive article. For example, the automotive articles are preferably selected from the group consisting of pressurized vessels, airbag modules, bumpers, side trims, step assists, body panels, spoilers, dashboards, interior trims and the like.

A further aspect of the present invention relates to the use of the fiber-reinforced composite (FR-C) as defined above for automotive articles.

In the light of the above the following embodiments are especially preferred:

[01] Fiber-reinforced composite (FR-C) comprising
a) a matrix (M) comprising a polypropylene (PP), and
b) olefin homopolymer fibers (F-OH) and/or olefin copolymer fibers (F-OC) dispersed in said matrix.

[02] Fiber-reinforced composite (FR-C) according to paragraph [01] wherein the melting temperature of the matrix (M) and/or of the polypropylene (PP) is in the range of +/−10° C. of the melting temperature of the homopolymer fibers (F-OH) and/or the olefin copolymer fibers (F-OC).

[03] Fiber-reinforced composite (FR-C) according to paragraph [01] or [02], wherein the melting temperature of the matrix (M) and/or of the polypropylene (PP) is not more than 30° C. above the melting temperature of the homopolymer fibers (F-OH) and/or the olefin copolymer fibers (F-OC).

[04] Fiber-reinforced composite (FR-C) according to according to any one of the preceding paragraphs [01] to [03], wherein the melting temperature of the matrix (M) and/or of the polypropylene (PP) is +/−30° C. of the melting temperature of the homopolymer fibers (F-OH) and/or the olefin copolymer fibers (F-OC).

[05] Fiber-reinforced composite (FR-C) according to any one of the preceding paragraphs [01] to [04], wherein
(a) the melting temperature of the matrix (M) and/or of the polypropylene (PP) is in the range of is below 175, preferably in the range of 130 to 175° C.;

and/or
(b) melting temperature of the homopolymer fibers (F-OH) and/or the olefin copolymer fibers (F-OC) is in the range of 125 to 170° C.

[06] Fiber-reinforced composite (FR-C) according to any one of the preceding paragraphs [01] to [05], wherein the fiber-reinforced composite (FR-C) comprises
(a) 50 to 99.9 wt.-% of the matrix (M), and
(b) 0.1 to 50 wt.-% of olefin homopolymer fibers (F-OH) and/or olefin copolymer fibers (F-OC),

based on the total weight of the fiber-reinforced composite (FR-C).

[07] Fiber-reinforced composite (FR-C) according to any one of the preceding paragraphs [01] to [06], wherein the fiber-reinforced composite (FR-C)
(a) comprises not more than 10 wt.-% based on the total amount of the fiber-reinforced composite (FR-C) fibers other than the olefin homopolymer fibers (F-OH) and/or the olefin copolymer fibers (F-OC);

or
(b) is free of any fibers being not polymer fibers, preferably being not olefin homopolymer fibers (F-OH) and/or olefin copolymer fibers (F-OC).

[08] Fiber-reinforced composite (FR-C) according to any one of the preceding paragraphs [01] to [07], wherein the polypropylene (PP) is a propylene homopolymer (H-PP1) and/or a propylene copolymer (C-PP1), preferably the polypropylene (PP) is a propylene copolymer (C-PP1).

[09] Fiber-reinforced composite (FR-C) according to any one of the preceding paragraphs [01] to [08], wherein the matrix (M) and/or the polypropylene (PP) has/have a melt flow rate MFR₂ (230° C.) measured according to ISO 1133 of from 1 to 500 g/10 min preferably of from 8 to 80 g/10 min.

[10] Fiber-reinforced composite (FR-C) according to any one of the preceding paragraphs [01] to [09], wherein the polypropylene (PP) is a heterophasic propylene copolymer (HECO) comprising a polypropylene matrix (M-HECO), preferably the polypropylene matrix (M-HECO) is a propylene homopolymer (H-PP2), and dispersed therein an elastomeric copolymer (E).

[11] Fiber-reinforced composite (FR-C) according to paragraph [10], wherein the heterophasic propylene copolymer (HECO) has
(a) a xylene cold soluble content (XCS) measured according ISO 6427 (23° C.) of not more than 35 wt.-%,

and/or
(b) a melt flow rate MFR₂ (230° C.) measured according to ISO 1133 of from 4 to 40 g/10 min.

[12] Fiber-reinforced composite (FR-C) according to any one of the preceding paragraphs [01] to [11], wherein the olefin homopolymer fibers (F-OH) and/or olefin copolymer fibers (F-OC) are olefin homopolymer fibers (F-OH), preferably propylene homopolymer fibers (F-PH).

[13] Fiber-reinforced composite (FR-C) according to any one of the preceding paragraphs [01] to [13], wherein the olefin homopolymer fibers (F-OH) and/or olefin copolymer fibers (F-OC) are in the form of fiber bundles, preferably in the form of continuous fiber bundles.

[14] Automotive article comprising the fiber-reinforced composite (FR-C) according to any one of paragraphs [01] to [13].

[15] Automotive article according to paragraph [14], wherein the automotive article is an exterior or interior automotive article.

[16] Use of the fiber-reinforced composite (FR-C) according to any one of paragraphs [01] to [13] for automotive articles.

[17] Process for the preparation of the fiber-reinforced composite (FR-C) according to any one of paragraphs [01] to [13] comprising the steps of
(a) providing a molten polypropylene (PP),
(b) providing the olefin homopolymer fibers (F-OH) and/or olefin copolymer fibers (F-OC),
(c) impregnating the olefin homopolymer fibers (F-OH) and/or olefin copolymer fibers (F-OC) of step b) with molten polypropylene (PP) of step a) such as to obtain said fiber-reinforced composite (FR-C).

[18] The process according to paragraph [17], wherein impregnating step c) is carried out such that the matrix (M) of step a) is molten and the olefin homopolymer fibers (F-OH) and/or olefin copolymer fibers (F-OC) of step b) are substantially in solid form.

The present invention will now be described in further detail by the examples provided below.

### EXAMPLES

### 1. Definitions/Measuring Methods

The following definitions of terms and determination methods apply for the above general description of the invention as well as to the below examples unless otherwise defined.

Quantification of Isotacticity in Polypropylene by ¹³C NMR Spectroscopy

The isotacticity is determined by quantitative ¹³C nuclear magnetic resonance (NMR) spectroscopy after basic assignment as e.g. in: V. Busico and R. Cipullo, Progress in Polymer Science, 2001, 26, 443-533. Experimental parameters are adjusted to ensure measurement of quantitative spectra for this specific task as e.g. in: S. Berger and S. Braun, 200 and More NMR Experiments: A Practical Course, 2004, Wiley-VCH, Weinheim. Quantities are calculated using simple corrected ratios of the signal integrals of representative sites in a manner known in the art. The isotacticity is determined at the pentad level i.e. mmmm fraction of the pentad distribution.

Quantification of Comonomer Content by FTIR Spectroscopy

The comonomer content is determined by quantitative Fourier transform infrared spectroscopy (FTIR) after basic assignment calibrated via quantitative ¹³C nuclear magnetic resonance (NMR) spectroscopy in a manner well known in the art. Thin films are pressed to a thickness of between 100-500 μm and spectra recorded in transmission mode. Specifically, the ethylene content of a polypropylene-co-ethylene copolymer is determined using the baseline corrected peak area of the quantitative bands found at 720-722 and 730-733 cm⁻¹. Specifically, the butene or hexene content of a polyethylene copolymer is determined using the baseline corrected peak area of the quantitative bands found at 1377-1379 cm⁻¹. Quantitative results are obtained based upon reference to the film thickness.

Randomness: In the FTIR measurements, films of 250-mm thickness were compression moulded at 225° C. and investigated on a Perkin-Elmer System 2000 FTIR instrument. The ethylene peak area (760-700 cm⁻¹) was used as a measure of total ethylene content. The absorption band for the structure -P-E-P- (one ethylene unit between propylene units), occurs at 733 cm⁻¹ This band characterizes the random ethylene content. For longer ethylene sequences (more than two units), an absorption band occurs at 720 cm⁻¹. Generally, a shoulder corresponding to longer ethylene runs is observed for the random copolymers. The calibration for total ethylene content based on the area and random ethylene (PEP) content based on peak height at 733 cm⁻¹ was made by ¹³C⁻NMR. (Thermochimica Acta, 66 (1990) 53-68).

Randomness=random ethylene (-P-E-P-) content/the total ethylene content×100%.

Melting temperature Tₘ is measured with Mettler TA820 differential scanning calorimetry (DSC) on 5-10 mg samples. Both crystallization and melting curves were obtained during 10° C./min cooling and heating scans between 30° C. and 225° C. Melting and crystallization temperatures were taken as the peaks of endotherms and exotherms. The DSC is run according to ISO 11357-3:1999

MFR₂ (230° C.) is measured according to ISO 1133 (230° C., 2.16 kg load).

The xylene cold solubles (XCS, wt.-%): Content of Xylene solubles (XCS) is determined at 23° C. according ISO 6427.

Intrinsic viscosity is measured according to DIN ISO 1628/1, October 1999 (in Decalin at 135° C.).

The tensile modulus; tensile Stress; tensile strain are measured at 23° C. according to ISO 527-1 (cross head speed 1 mm/min) using injection moulded specimens according to ISO 527-2(1B), produced according to EN ISO 1873-2 (dog bone shape, 4 mm thickness).

Average Fiber Diameter:

Determined according to ISO 1888:2006(E), Method B, microscope magnification of 1000.

### 2. Examples

The following inventive examples IE1, IE2, IE3 and IE4 and comparative examples CE1, CE2, CE3 and CE4 were prepared. Polypropylene fibres (F) as defined below of 16 cm length were placed on a dog bone cavity which was injection moulded according to EN ISO 1873-2 (dog bone shape, 4 mm thickness) with polypropylene (PP). The details regarding the polypropylene (PP) forming the matrix (M) and fibers (F) can be gathered form Table 1.

TABLE 1
Composition of examples and comparative examples

| | Matrix (M) | | Fiber (F) | |
|---|---|---|---|---|
| | Type | [wt.-%] | Type | [wt.-%] |
| IE1 | BF970MO | 94 | homo-PP-strap (smooth surface) | 6 |
| IE2 | BF970MO | 88 | homo-PP-strap (smooth surface) | 12 |
| IE3 | BF970MO | 94 | homo-PP-strap (ribbed surface) | 6 |
| IE4 | EF50HP | 88 | homo-PP-strap (smooth surface) | 12 |
| CE1 | BF970MO | 100 | — | 0 |
| CE2 | EF50HP | 100 | — | 0 |

| | |
|---|---|
| CE3 | GB215HP |
| CE4 | GB205U |

BF970MO is a commercially heterophasic propylene copolymer of Borealis AG having an MFR₂ (230° C.) of 20 g/10 min, a total comomoner content (C₂) of 8.0 wt.-%, a content of xylene cold solubles (XCS) of 17.5 wt.-% and a melting temperature of 166° C..
Daplen EF150HP is a commercially available polypropylene TPO compound of Borealis AG having an MFR₂ (230° C.) of 22 g/10 min, a total comomoner content (C₂) of 16 wt.-%, a content of xylene cold solubles (XCS) of 23 wt.-% and a melting temperature of 165° C..
homo-PP-strap (smooth surface) is a commercially strapping product of Teufelberger Ges.m.b.H. sold under the tradename TEWE PP A having a melting temperature of 168° C. and a fibre strap width of 8 mm and a fibre stap thickness of 0.3 mm.
homo-PP-strap (ribbed surface) is a commercially available strapping product of Teufelberger Ges.m.b.H. sold under the tradename TEWE PP A having a melting temperature of 168° C. and a fibre strap width of 8 mm and a fibre stap thickness of 0.3 mm
Nepol GB215HP is a commercially reinforced composite of Borealis AG containing 22 wt.-% long glass fiber embedded in a propylene copolymer matrix, having an MFR₂ (230° C.) of 2 g/10 min and a melting temperature of 166° C..
GB205U is a commercially glass fibre reinforced composite of Borealis AG containing 20 wt.-% chemically coupled glass fibers embedded in a propylene homopolymer matrix, having an MFR₂ (230° C.) of 2.2 g/10 min and a melting temperature of 166° C..

TABLE 2
Results of inventive Examples and comparative examples

| | | IE1 | IE2 | IE3 | IE4 | CE1 | CE2 | CE3 | CE4 |
|---|---|---|---|---|---|---|---|---|---|
| TM | [MPa] | 1793.6 | 2420.6 | 1879.5 | 3031 | 1530.2 | 2052.9 | 5300 | 4800 |
| TSR | [MPa] | 51.8 | 78.4 | 45.1 | 69.1 | 27 | 21.9 | 104.5 | 74.6 |
| TSA | [%] | 11.9 | 11.1 | 10.4 | 8.5 | 4.1 | 3.8 | 2.7 | 3.8 |
| TSS | [MPa] | 50.8 | 77.8 | 45 | 60.9 | 27 | 21.9 | 105 | 74.6 |
| TSAT | [%] | 11.31 | 11.08 | 10.42 | 6.76 | 4.12 | 3.8 | 2.7 | 3.8 |
| TSSB | [MPa] | 37.8 | 58.6 | 22.8 | 30.4 | 16.2 | 14.8 | 105 | 75 |
| TSAB | [%] | 17.13 | 12.08 | 19.07 | 10.94 | 32.79 | 40.72 | 2.7 | 4.1 |
| ash | [wt %] | 0.5 | 0.6 | 0.5 | 15 | 0.6 | 16 | 22 | 20 |

TM Tensile modulus
TSR Tensile stress at yield
TSA Tensile strain at yield
TSS Tensile strength
TSAT Tensile strain at tensile strength
TSSB Tensile stress at yield at break
TSAB Tensile strain at yield at break

The fiber-reinforced composites (FR-C) according to the inventive examples show excellent mechanical properties such as a high tensile modulus, tensile stress and strain which further feature a light weight and are easy to recycle.

Table 2 demonstrates clearly that the inventive fiber-reinforced composites (FR-C) comprising a matrix (M) and olefin homopolymer fibers (F-OH) and/or olefin copolymer fibers (F-OC) dispersed in said matrix (M) show increased levels of tensile stress in combination with very high tensile strain at yield. In particular, it is shown that the values determined for the tensile strain at yield of the fiber-reinforced composites (FR-C) according to the inventive examples are significantly higher than the values determined for the comparative sample.

1. Fiber-reinforced composite (FR-C) comprising
a) a matrix (M) comprising a polypropylene (PP), and
b) olefin homopolymer fibers (F-OH) and/or olefin copolymer fibers (F-OC) dispersed in said matrix,
and wherein the melting temperature of the matrix (M) and/or of the polypropylene (PP) is in the range of +/−20° C., like in the range of +/−10° C., of the melting temperature of the homopolymer fibers (F-OH) and/or the olefin copolymer fibers (F-OC).

2. Fiber-reinforced composite (FR-C) according to claim 1, wherein the melting temperature of the matrix (M) and/or of the polypropylene (PP) is not more than 20° C., like not more than 10° C., above the melting temperature of the homopolymer fibers (F-OH) and/or the olefin copolymer fibers (F-OC).

3. Fiber-reinforced composite (FR-C) according to claim 1 or 2, wherein the melting temperature of the matrix (M) and/or of the polypropylene (PP) is +/−5° C. of the melting temperature of the homopolymer fibers (F-OH) and/or the olefin copolymer fibers (F-OC).

4. Fiber-reinforced composite (FR-C) according to any one of the preceding claims, wherein
(a) the melting temperature of the matrix (M) and/or of the polypropylene (PP) is in the range of is below 175, preferably in the range of 130 to 175° C.;
and/or
(b) melting temperature of the homopolymer fibers (F-OH) and/or the olefin copolymer fibers (F-OC) is in the range of 125 to 170° C.

5. Fiber-reinforced composite (FR-C) according to any one of the preceding claims, wherein the fiber-reinforced composite (FR-C) comprises
(a) 50 to 99.9 wt.-% of the matrix (M), and
(b) 0.1 to 50 wt.-% of olefin homopolymer fibers (F-OH) and/or olefin copolymer fibers (F-OC),
based on the total weight of the fiber-reinforced composite (FR-C).

6. Fiber-reinforced composite (FR-C) according to any one of the preceding claims, wherein the fiber-reinforced composite (FR-C)
(a) comprises not more than 10 wt.-% based on the total amount of the fiber-reinforced composite (FR-C) fibers other than the olefin homopolymer fibers (F-OH) and/or the olefin copolymer fibers (F-OC);
or
(b) is free of any fibers being not polymer fibers, preferably being not olefin homopolymer fibers (F-OH) and/or olefin copolymer fibers (F-OC).

7. Fiber-reinforced composite (FR-C) according to any one of the preceding claims, wherein the polypropylene (PP) is a propylene homopolymer (H-PP1) and/or a propylene copolymer (C-PP1), preferably the polypropylene (PP) is a propylene copolymer (C-PP1).

8. Fiber-reinforced composite (FR-C) according to any one of the preceding claims, wherein the matrix (M) and/or the polypropylene (PP) has/have a melt flow rate MFR₂ (230° C.) measured according to ISO 1133 of from 1 to 500 g/10 min preferably of from 8 to 80 g/10 min.

9. Fiber-reinforced composite (FR-C) according to any one of the preceding claims, wherein the polypropylene (PP) is a heterophasic propylene copolymer (HECO) comprising a polypropylene matrix (M-HECO), preferably the polypropylene matrix (M-HECO) is a propylene homopolymer (H-PP2), and dispersed therein an elastomeric copolymer (E).

10. Fiber-reinforced composite (FR-C) according to claim 9, wherein the heterophasic propylene copolymer (HECO) has
(a) a xylene cold soluble content (XCS) measured according ISO 6427 (23° C.) of not more than 35 wt.-%,
and/or
(b) a melt flow rate MFR₂ (230° C.) measured according to ISO 1133 of from 4 to 40 g/10 min.

11. Fiber-reinforced composite (FR-C) according to any one of the preceding claims, wherein the olefin homopolymer fibers (F-OH) and/or olefin copolymer fibers (F-OC) are olefin homopolymer fibers (F-OH), preferably propylene homopolymer fibers (F-PH).

12. Fiber-reinforced composite (FR-C) according to any one of the preceding claims, wherein the olefin homopolymer fibers (F-OH) and/or olefin copolymer fibers (F-OC) are in the form of fiber bundles, preferably in the form of continuous fiber bundles.

13. Automotive article comprising the fiber-reinforced composite (FR-C) according to any one of claims 1 to 12.

14. Automotive article according to claim 13, wherein the automotive article is an exterior or interior automotive article.

15. Use of the fiber-reinforced composite (FR-C) according to any one of claims 1 to 12 for automotive articles.

16. Process for the preparation of the fiber-reinforced composite (FR-C) according to any one of claims 1 to 12 comprising the steps of
(a) providing a molten polypropylene (PP),
(b) providing the olefin homopolymer fibers (F-OH) and/or olefin copolymer fibers (F-OC),
(c) impregnating the olefin homopolymer fibers (F-OH) and/or olefin copolymer fibers (F-OC) of step b) with molten polypropylene (PP) of step a) such as to obtain said fiber-reinforced composite (FR-C).

17. The process according to claim 16, wherein impregnating step c) is carried out such that the matrix (M) of step a) is molten and the olefin homopolymer fibers (F-OH) and/or olefin copolymer fibers (F-OC) of step b) are substantially in solid form.
